(19) United States
(12) Patent Application Publication
(10) Pub. No.: US 2005/0128656 A1
(43) Pub. Date: Jun. 16, 2005

(54) Semiconductor switch pulse discharge module

(76) Inventor: James T. Croyle, Sinking Spring, PA (US)

Correspondence Address: Liniak, Berenato & White, Ste. 240, 6550 Rock Spring Drive, Bethesda, MD, 20817, US

(21) Appl. No.: 10/735,656

(22) Filed: Dec. 16, 2003

(51) Int. Cl. H02H 7/00

(52) U.S. Cl. 361/18

(57) ABSTRACT

A capacitor-type pulse discharge apparatus for generating an electric current pulse through an electrical load, comprises an electrical power source and at least one pulse discharge switch module. The pulse discharge switch module includes a capacitor for storing an electrical energy, a semiconductor high-power switch and a semiconductor low-power switch connected to the same terminal of the capacitor. The high-power switch has an input connected in series to the capacitor for allowing the stored electrical energy to be transferred from the capacitor to the load, and the low-power switch has an input connected in series to the capacitor for allowing charging supply from the electrical power source to charge the capacitor.

### BACKGROUND OF THE INVENTION

1. Field of the Invention

The present invention relates to capacitor-type pulse discharge apparatuses and, more particularly, to a semiconductor pulse discharge switch module for the capacitor-type pulse discharge apparatus.

2. Description of the Prior Art

Capacitor-type pulse discharge apparatuses are used in various applications, and are known in the art. Conventionally, the capacitor-type pulse discharge apparatuses employ vacuum switches, spark-gap switches, thyratrons or ignitrons as switching devices. The switching devices currently used in the capacitor-type pulse discharge apparatuses offer little consistancy, are high expense, need frequent maintainance, and are incapable of production level reliability.

Accordingly, it is the intent of this invention to overcome these shortcomings of the prior art.

### SUMMARY OF THE INVENTION

The present invention provides a novel capacitor-type pulse discharge apparatus for generating an electric current pulse through an electrical load.

The capacitor-type pulse discharge apparatus of the present invention comprises the electrical load, at least one pulse discharge switch module, and an electrical power source. The at least one pulse discharge switch module includes at least one capacitor for storing an electrical energy, a semiconductor high-power switch and a semiconductor low-power switch connected to the same terminal of the capacitor. The high-power switch has an input connected in series to the at least one capacitor for allowing the stored electrical energy to be transferred from the capacitor to the load, and the low-power switch has an input connected in series to the at least one capacitor for allowing charging supply from the electrical power source to charge the capacitor.

Preferably, the capacitor-type pulse discharge apparatus in accordance with the preferred embodiment of the present invention comprises a plurality of substantially identical pulse discharge switch modules connected in parallel with one another., and a module trigger selector that controls each the plurality of the pulse discharge switch modules independently and selectively, thus providing the pulse discharge apparatus of the present invention with the ability to select the number of modules used in each pulse and to fine tune the shape of the pulse to a particular application.

Therefore, the capacitor-type pulse discharge apparatus in accordance with the present invention provides a reliable and consistent switching mechanism for pulse power, and a flexible pulse power supply.

### BRIEF DESCRIPTION OF THE DRAWINGS

Other objects and advantages of the invention will become apparent from a study of the following specification when viewed in light of the accompanying drawings, wherein:

FIG. 1 is a schematic electrical circuit of a capacitor-type pulse discharge apparatus in accordance with the present invention;

FIG. 2 is a schematic electrical circuit of a pulse discharge switch module for the pulse discharge apparatus in accordance with the present invention;

FIG. 3 is a schematic electrical circuit of the pulse discharge switch module for the pulse discharge apparatus in accordance with the preferred exemplary embodiment of the present invention;

FIG. 4 shows a plurality of selectable current pulses generated by the pulse discharge apparatus in accordance with the exemplary embodiment of the present invention.

### DETAILED DESCRIPTION OF PREFERRED EMBODIMENTS

The preferred exemplary embodiment of the present invention will now be described with the reference to accompanying drawings.

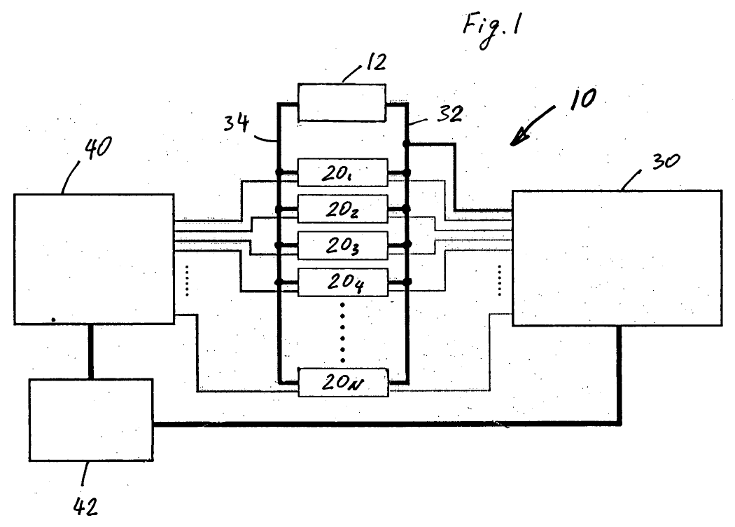

FIG. 1 depicts an exemplary embodiment of a modular pulse discharge apparatus 10 in accordance with the present invention. Examples of the pulse discharge apparatus 10 may be magnetic pulse welding machines, discharge pulse generators for supplying power between a pair of electrodes, etc.

The modular pulse discharge apparatus 10 is provided to generate a large current pulse and comprises an electrical load 12, at least one pulse discharge switch module 20₁, and a D.C. electrical power source 30. As illustrated in FIG. 1, the electrical load 12 is electrically connected to a common bus 32 and a positive bus 34. Those skilled in the art would appreciate that the electrical load 12 may be in the form of any appropriate electrical power consuming element, such as an inductive coil of the magnetic pulse welding machine, a pair of electrodes, etc. In case when the electrical load 12 is the inductive weld coil of the magnetic pulse welding machine, a current pulse generated by the pulse discharge apparatus creates a magnetic field at a weld coil output, which is essential to creating a magnetic pulse weld.

Preferably, as illustrated in FIG. 1, the modular pulse discharge apparatus 10 of the present invention includes a plurality of substantially identical pulse discharge switch modules 20₁ . . . 20_{N} each electrically connected to the common bus 32 and the positive bus 34 in parallel with one another. It will be appreciated that the modular pulse discharge apparatus 10 of the present invention may include tens to hundreds of the pulse discharge switch modules 20₁ . . . 20_{N}.

The modular pulse discharge apparatus 10 of the exemplary embodiment of the present invention further includes a module trigger selector 40 electrically coupled to each of the plurality of the pulse discharge switch modules 20₁ . . .20_{N}, and a human interface device 42 connected to both the electrical power source 30 and the module trigger selector 40. Alternatively, the module trigger selector 40 may be optically coupled to each of the plurality of the pulse discharge switch modules 20₁ . . . 20_{N}, through a fiber optic cable (not shown) transmitting a pulse of light. The module trigger selector 40 is provided to control each the plurality of the pulse discharge switch modules 20₁ . . . 20_{N}, and, in turn, is controlled by the human interface device 42. Preferably, the module trigger 40 is some sort of programmable logic control (PLC). Further preferably, the module trigger selector 40 controls each the plurality of the pulse discharge switch modules 20₁ . . . 20_{N} independently and selectively, thus providing the pulse discharge apparatus 10 with the ability to select the number of modules 20_{1 . . . 20}_{N} used in each pulse (i.e. operate a selected number of the plurality of the pulse discharge switch modules 20₁ . . . 20_{N}) and to fine tune the shape of the pulse to a particular application.

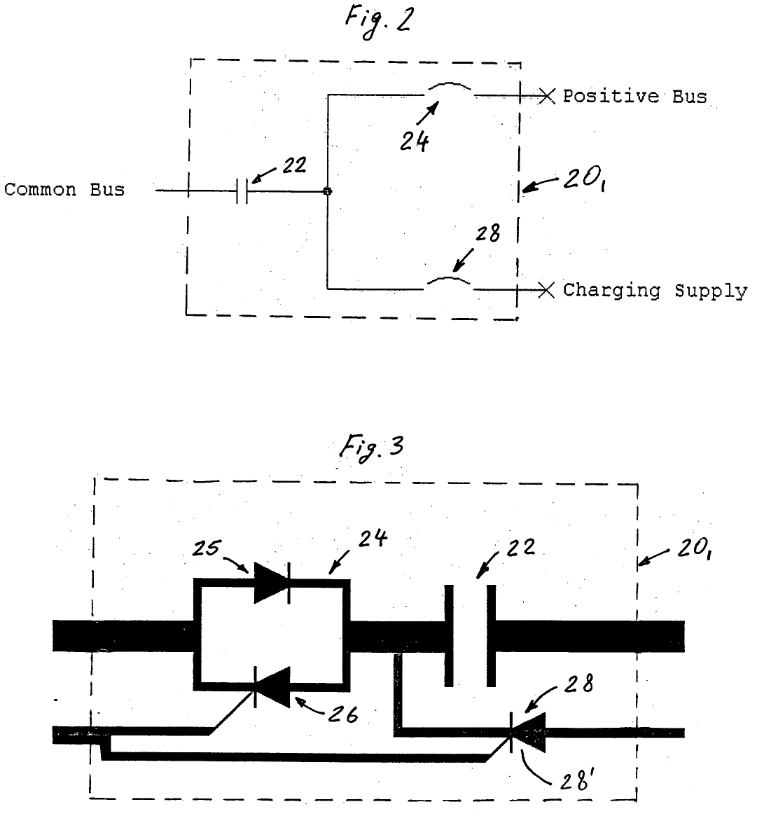

As noted above, the pulse discharge switch modules 20₁ . . . 20_{N} are substantially identical, and each module 20₁ . . . 20_{N} includes three main parts: a capacitor 22 (capacitance is determined by the overall desired flexibility and application), a semiconductor low-power switch 28 (used in the selectable charging of the capacitor 22 with a charging current from the electrical power source 30), and a semiconductor high-power switch 24 which accomplishes the main discharge of the capacitor 22 (only the pulse discharge switch module 20₁ is illustrated in detail in FIG. 2). It will be appreciated that the low-power switch 28 may be structurally identical to the high-power switch 24.

The use of the solid state switches offers a number of advantages over the pulse power supplies of the prior art: solid state switches are extremely consistant from pulse to pulse (a significant advantage over spark gap and vacuum switches); solid state switches may be easily configured to fire via a fiber-optically transmitted pulse of light (beneficial in high-voltage high-power applications which are inherently dangerous and electrically noisy), solid state switches are easily controlled using almost any conventional PLC, and, finally, proper thermal management of solid state switches enables lifetimes in the tens of millions at high repetition rates as opposed to spark gap and vacuum switches which require maintainance after hundreds to thousands of firings, and ignitrons which are unable to withstand high repetition rates.

The operation of the pulse discharge apparatus 10 is as follows: the load 12 is connected between a high side of the high power switch 24 and the common bus 34, while the charging supply is connected between a high side of the low power switch 28 and the common bus 34. Prior to pulsing, the low power switch 28 is closed, allowing the charging supply from the electrical power source 30 to charge the capacitor 22. Once the desired voltage of the capacitor 22 is reached, the low power switch 28 is opened, and the high power switch 24 is subsecuently closed to actuate the current pulse from the capacitor 22 to the electrical load 12. The pulse discharge switch modules 20₁ . . . 20_{N} are controlled by the module trigger selector 40 via the human interface device 42.

The preferred exemplary embodiment of each of the pulse discharge switch modules 20₁ . . . 20_{N} is illustrated in FIG. 3. As illustrated, the low-power solid state switch 28 is in the form of a semiconductor-controlled rectifier (SCR) 28′, and the high-power switch 24 includes a diode 25 and a semiconductor-controlled rectifier (SCR) 26 connected in parallel. The low power SCR 28′ on the selected module is turned on to allow charging of the capacitor 22, while the high power SCR 26 in the selected module is actuated to produce the current pulse when the low power SCR 28′ is turned off. The diode 25 handles any reverse current which the circuit produces. It will be appreciated that any appropriate SCRs may be used in the pulse discharge switch modules of the present invention. The SCRs chosen for the purpose need to be capable of handling the current, voltage, and frequency of the particular application.

The shape of the current pulse, produced in the discharge, is greatly dependent of the amount of capacitance used. Corresponding;y, the number of pulse discharge switch modules 20₁ . . . 20_{N} and the size of the capacitor in each module and power handling capability of the switches depend of the nature of the application. Moreover, the shape of the current pulse is controlled entirely by the circuit parameters, such as, depending on the specific application, inductance, resistance, capacitance and voltage. Furthermore, the shape of the current pulse has a great effect on the functionality of the pulse discharge apparatus 10 in the specific application, such as the quality of the weld in the magnetic pulse welding machine application when the load 12 is in the form of the inductive coil. This being the case, it would be greatly beneficial to be able to dynamically change the circuit parameters between pulses. This is allowed by the modular approach of the present invention. As the present invention allows to employ practically any number of the pulse discharge switch modules 20₁ . . . 20_{N} for each additional module, the capacitance is incremented, and the peak current is elevated. Furthermore, as the module trigger selector 40 controls each the plurality of the pulse discharge switch modules 20₁ . . . 20_{N} independently and selectively, the pulse discharge apparatus 10 has the ability to approprietly select the number of modules 20₁ . . . 20_{N} used in each pulse, and to fine tune the shape of the pulse to a particular application.

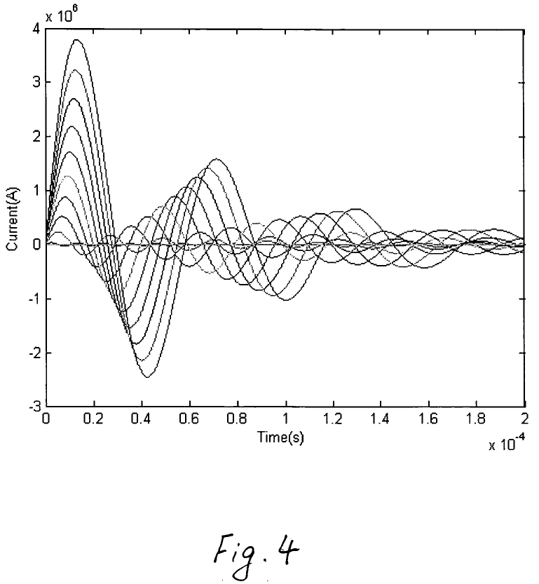

In the specific exemplary application of the pulse discharge apparatus 10 of the present invention as the magnetic pulse welding machine, the thyristor 5SPY 08F45000 produced by ABB Switzerland Ltd. May be employed in the pulse discharge switch modules. This SCR is capable of 30 kA peak current, and 4500V blocking ability. Assuming a modestly low resistance and inductance in the circuit, and 30 pulse discharge switch modules each with a capacitance of 30 μF, the pulse discharge apparatus 10 would be able to produce the range of waveforms shown in FIG. 4. The FIG. 4 shows a waveform for every three pulse discharge switch modules selected, so even finer resolution is available. By choosing the correct components for the modular pulse discharge apparatus of the present invention, a wide range of selections is possible.

Therefore, the modular pulse discharge apparatus in accordance with the present invention including a plurality of independently and selectively controlled pulse discharge switch modules, provides a wide range of flexible pulse power supplies.

The foregoing description of the preferred exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. A pulse discharge apparatus comprising:
an electrical load;
an electrical power source; and
at least one pulse discharge switch module;
said at least one pulse discharge switch module including:
at least one capacitor for storing an electrical energy;
a semiconductor high-power switch having an input connected in series to said at least one capacitor for allowing said stored electrical energy to be transferred from said at least one capacitor to said load; and
a semiconductor low-power switch having an input connected in series to said at least one capacitor for allowing charging supply from said electrical power source charge said at least one capacitor;
wherein said high-power switch and said low-power switch are connected to the same terminal of said at least one capacitor.

2. The pulse discharge apparatus as defined in claim 1, including a plurality of said pulse discharge switch modules connected in parallel with one another.

3. The pulse discharge apparatus as defined in claim 2, wherein said plurality of said pulse discharge switch modules are substantially identical to each other.

4. The pulse discharge apparatus as defined in claim 1, wherein said at least one pulse discharge switch module includes a plurality of said capacitors connected in series or in parallel with one another.

5. The pulse discharge apparatus as defined in claim 1, further including a module trigger selector provided for controlling said at least one pulse discharge switch module and operatively coupled thereto.

6. The pulse discharge apparatus as defined in claim 5, further including a human interface device provided for controlling said module trigger selector.

7. The pulse discharge apparatus as defined in claim 2, further including a module trigger selector operatively coupled to each of said plurality of said pulse discharge switch modules, said module trigger selector is provided for independently and selectively controlling each of said plurality of said pulse discharge switch modules in order to selectively operate a selected number of said plurality of said pulse discharge switch modules.

8. The pulse discharge apparatus as defined in claim 7, further including a human interface device provided for controlling said module trigger selector.

9. The pulse discharge apparatus as defined in claim 1, wherein said low-power switch of said at least one pulse discharge switch module includes a semiconductor-controlled rectifier.

10. The pulse discharge apparatus as defined in claim 1, wherein said high-power switch of said at least one pulse discharge switch module includes a semiconductor-controlled rectifier.

11. The pulse discharge apparatus as defined in claim 10, wherein said high-power switch of said at least one pulse discharge switch module further includes a diode connected in parallel to said semiconductor-controlled rectifier.

12. The pulse discharge apparatus as defined in claim 1, wherein said pulse discharge apparatus is a magnetic pulse welding machine.

13. The pulse discharge apparatus as defined in claim 12, wherein said electrical load is an inductive coil of said magnetic pulse welding machine.

14. The pulse discharge apparatus as defined in claim 1, wherein said electrical power source provides a charging current to said at least one capacitor.

15. A pulse discharge apparatus comprising:
an electrical load;
a D.C. electrical power source;
a plurality of substantially identical pulse discharge switch modules connected in parallel with one another;
each of said pulse discharge switch modules including:
a capacitor for storing an electrical energy;
a semiconductor high-power switch having an input connected in series to said capacitor for allowing said stored electrical energy to be transferred from said capacitor to said load, said high-power switch including a semiconductor-controlled rectifier and a diode connected in parallel to said semiconductor-controlled rectifier;
a semiconductor low-power switch having an input connected in series to said capacitor for allowing charging supply from said electrical power source charge said capacitor, said low-power switch including a semiconductor-controlled rectifier;
said high-power switch and said low-power switch are connected to the same terminal of said capacitor;
a module trigger selector electrically coupled to each of said plurality of said pulse discharge switch modules, said module trigger selector provided for independently and selectively controlling each of said plurality of said pulse discharge switch modules in order to selectively operate a selected number of said plurality of said pulse discharge switch modules; and
a human interface device provided for controlling said module trigger selector.
